(19) United States
(12) Patent Application Publication
(10) Pub. No.: US 2012/0312930 A1
(43) Pub. Date: Dec. 13, 2012

(54) STRUCTURE FOR REDUCING A FLOW RESISTANCE OF A BODY IN A FLUID

(76) Inventor: Marco Feusi, Bioggio (CH)

(21) Appl. No.: 13/575,137

(22) PCT Filed: Jan. 28, 2011
(86) PCT No.: PCT/CH2011/000010

§ 371 Date: Jul. 25, 2012

(30) Foreign Application Priority Data
Jan. 28, 2010 (CH) 100/10

(51) Int. Cl. B64C 23/06

(52) U.S. Cl. 244/200.1; 244/130

(57) ABSTRACT

The invention relates to a body (10) having at least one surface (12) over which a fluid (30) can flow, said surface having a global course that defines a main flow direction (14) over the surface (12) at least partially has a structure for reducing a flow resistance of the body (10), the structure having at least one recess (16.2 . . . 16.3) provided with a substantially circle-segment-shaped cross-section for inducing a fluid eddy (26.2) . . . 26.3). The body is characterized in that the structure has at least one lead-in section (18.2 . . . 18.3), which is angled from the main flow direction in the direction of the recess (16.2 . . . 16.3) and which is arranged upstream of the recess (16.2 . . . 16.3) in the main flow direction, for leading a fluid flow (24) into the recess (16.2 . . . 16.3). By means of the structure, a fluid eddy (26.2 . . . 26.3) can be induced within the recess (16.2 . . . 16.3) and can be localized substantially within the recess (16.2 . . . 16.3).

### TECHNICAL FIELD

The invention relates to a body having at least one surface over which a fluid can flow, said surface having a global course that defines a main flow direction over the surface wherein the surface at least partially has a structure for reducing a flow resistance of the body, the structure having at least one recess provided with a substantially circle-segment-shaped cross-section for inducing a fluid eddy. The invention further relates to a film having a corresponding surface structure.

### PRIOR ART

In aircraft construction but also, for example, in ship construction or in the design of high-speed trains and vehicles, it is very important to achieve a shape and also a surface which is as low-drag as possible. The advantages of an aircraft, ship or vehicle with good flow characteristics, that is to say low flow resistance, are low energy requirements and therefore low fuel consumption on the one hand but also higher speeds can be achieved with the same drive power on the other hand. Therefore overall, a body with low flow resistance moves more efficiently through a fluid, e.g. air or water, which is particularly important where energy costs are high.

U.S. Pat. No. 2,899,150 describes an aircraft wing that has low surface friction in air. In this case, circular recesses are provided in a groove shape over the surface of the wing and transverse to the direction of flight and flow.

As a result, air eddies which contribute to reducing the wing's flow resistance arise in the recesses.

This idea is pursued further in U.S. Pat. No. 6,363,972 and various shapes of recesses are provided in the surface of a body over which air flows.

Both structures, however, have the drawback of a flow resistance which is still unsatisfactorily high.

Particularly in the case of jet-propelled aircraft, the flow resistance inside the jet engine makes a significant contribution to the aircraft's overall flow resistance. The air flow inside the propulsive unit is sometimes brought up to supersonic speed or, in the case of a supersonic flight condition, is already at supersonic speed. In this case, special hydrodynamic effects, not all of which are yet fully understood, can occur making the customary structures for reducing the flow resistance of a surface over which air flows, such as those referred to above, less effective.

### Presentation of the Invention

The object of the invention is thus to further reduce the flow resistance of a body in a fluid. The object further consists of also bringing about an effective reduction in the body's flow resistance for flow conditions with velocities above the speed of sound.

The object is achieved by means of the subject matter of claims 1, 14 and 15. Advantageous further embodiments are met by the dependent claims. The subject of the invention is a body having at least one surface over which a fluid can flow, said surface having a global course that defines a main flow direction over the surface wherein the surface at least partially has a structure for reducing a flow resistance of the body. In this case, the structure has at least one recess provided with a substantially circle-segment-shaped cross-section for inducing a fluid eddy. The body is characterized in that the structure has at least one lead-in section, which is angled with respect to the main flow direction towards the recess and which is arranged upstream of the recess in the main flow direction, for leading a fluid flow into the recess. By means of the structure, a fluid eddy can be induced within the recess and can be localized substantially within the recess.

The body therefore has a surface which extends over a considerable area. In this case, it may be both a flat or also a curved surface. Depending where applicable on the body's incident flow direction, the global course of the surface defines a main flow direction of a fluid over the surface, to some extent an averaged flow direction. Small structures on the surface are of only minor consequence in this case. The surface of the body according to the invention has a structure comprising at least one recess provided with a substantially circle-segment-shaped cross-section for inducing a fluid eddy and which is suitable and equipped for inducing a fluid eddy. The structure further comprises a lead-in section which is suitable and equipped for leading a fluid flow into the recess. On one hand, the lead-in section is upstream of the recess towards the main flow direction such that a fluid flow flowing over the surface first passes the lead-in section and is then led into the recess by this lead-in section. On the other hand, the lead-in section is angled towards the recess with respect to the main flow direction. This means that the lead-in section, with a global surface extending horizontally in the vertical direction, is angled towards the recess. The result is that part of the fluid flow flowing over the surface and passing the lead-in section is led into the recess by said lead-in section. A fluid eddy is generated in the recess due to the design of the recess and the fluid flow, said fluid eddy remains substantially inside the recess due to the design of the recess.

The diameter of the substantially circle-segment-shaped cross-section of the recess may in this case be preferably 8 mm for air which flows over the surface at 100 km/h (approximately 27.8 m/s). The preferred diameter increases linearly with the anticipated flow velocity of air. In the case of water as a fluid, the diameter in the cross-section of the recess is preferably 8 mm for water which flows over the surface at 6 km/h (approximately 1.7 m/s). This means that the dimension of the recess depends on the type of fluid flow to be anticipated. An empirical formula for dimensioning of the recess in the case of gases is d=8*v/1000 where d denotes the diameter of the recess in centimeters and v the velocity of the fluid flow in km/h The surface in the recess is preferably coated with TiO₂ as a result of which a particularly low flow resistance is achieved between the fluid eddy localized in the recess and the edge of the recess. The recess may also have a cross-section deviating from a circular shape.

This means that part of the fluid flow which flows directly over the surface is reliably and efficiently converted into a fluid eddy (Helmholtz eddy) by the lead-in section and the recess, said fluid eddy remaining substantially inside the recess. The fact that the fluid eddy remains substantially inside the recess means that the majority of the particles of the fluid located in the recess remain in the recess in a stationary eddy, that is to say they are not led out of the recess.

With a sustained fluid flow, the fluid eddy localized in the recess leads fluid particles away across the fluid eddy. Since the fluid eddy has a rotation velocity, the difference in velocity between the outer margin of the fluid eddy and the fluid flow led directly across the fluid eddy is very small such that the flow resistance of the body, which increases proportional to the flow velocity, can also be kept very small. In the region of the fluid eddy, the fluid flow flowing over the surface does not therefore come into direct contact with the (resting) body but rather only with the outer margin of the eddy. Moreover, an effective reduction of the flow resistance is also possible for supersonic velocities of the fluid flow due to the lead-in section.

In a preferred embodiment, the recess is extended substantially transverse to the main flow direction, in particular groove-shaped. The effect of the surface structure is greatest when the recess extends over the body transverse to the main flow direction. An angular deviation of up to 45° from the vertical to the main flow direction still enables a significant reduction in the flow resistance compared to known structures. In an especially preferred groove-shaped embodiment of the structure, the recess extends in the transverse direction to the main flow direction over the whole surface.

Advantageously, the structure has a plurality of recesses wherein the recesses of the plurality of recesses are arranged one behind the other, particularly in the main flow direction. The structure is particularly effective when many recesses lying one behind the other in the main flow direction are present on the surface of the body. As a result, a large area of the body can be provided with the structure and an especially effective reduction of the flow resistance is therefore possible. In this case, subsequent particles of the fluid flow which flows over the body's surface barely hit the surface of the body itself and are rather led almost completely away across the surface by the fluid eddy. In this case, the difference in velocity between the fluid flow layer which is nearest the surface and that of the fluid eddy is very small and consequently the flow resistance is also very small.

In the case of a plurality of recesses, it is particularly advantageous if adjacent recesses are spaced apart from each other by 1 to 6 times, in particular 1.1 to 1.75 times, preferably 1.25 to 1.5 times, and especially preferably 1.25 times the diameter of the circle-segment-shaped cross-section. The distance between the recesses is determined in each case between the center points of adjacent recesses. An especially large reduction in the body's flow resistance is achieved by a distance between the recesses which is dimensioned in this way, preferably towards the main flow direction.

Advantageously, the lead-in section is curved. In this case, the radius of curvature is preferably 1.1 to 1.75 times, in particular 1.25 to 1.5 times and especially preferably 1.25 times the diameter of the circle-segment-shaped cross-section whereby it can also be advantageous if it measures 2 to 6 times the diameter of the circle-segment-shaped cross-section. The fluid flow flowing directly across the body's surface is led into the recess in a particularly low-friction and safe manner due to such a curvature.

The lead-in section is preferably configured in such a manner that the inclination between the main flow direction and the tangent parallel to the main flow direction is greater at a first point of the lead-in section than at a second point which is situated upstream in the main flow direction with respect to the first point. This means that the inclination of the lead-in section to the main flow direction increases in the direction of the flow. This need not necessarily take place continuously, there may also be discrete portions of the lead-in section which are inclined differently with respect to the main flow direction whereby the inclination increases from portion to portion.

In a further preferred embodiment, the recess has a first edge situated upstream in the main flow direction between the lead-in section and the recess and a second edge situated downstream between the recess and a portion of the surface situated downstream. At the same time, the first edge is substantially offset with respect to the second edge towards the inside of the body in order to induce the fluid eddy in the recess. In this context, an edge is to be understood as an abrupt change in the orientation of the surface. It is present at transitions between each recess and the parts of the surface surrounding it. The fact that the first edge is offset with respect to the second edge substantially towards the inside of the body means conversely that the second edge protrudes to a certain extent in relation to the first edge away from the recess. The second edge is therefore a further element which makes it easier to lead the fluid flow into the recess and also marks out the structure particularly for the reduction of a flow resistance at supersonic flow rates.

In this case, the point of the recess situated furthest upstream, i.e. the edge of the recess, is advantageously offset with respect to the first edge towards the inside of the body in order to substantially localize the fluid eddy inside the recess. The point of the recess situated furthest upstream is located underneath the first edge. In this case, this means the point on the edge of the recess proceeding from which a fluid flow following the edge of the recess always (partially) moves downstream, that is towards the main flow direction. With a circle-segment-shaped cross-section of the recess, this point is typically a point with a tangent running perpendicular to the main flow direction on the edge of the recess. This means that a fluid particle of the fluid eddy inside the recess on the first edge moves at least partially towards the main flow direction. This is linked to secure localization of the fluid eddy substantially inside the recess.

In a preferred embodiment, the second edge is offset with respect to the center spot of the recess in the main flow direction by 0.1 to 0.6 times or by 0.1 to 0.5 times, preferably by 0.25 times and especially preferably by 0.3 times the radius of the circle-segment-shaped cross-section. This arrangement of the second edge relative to the circle-segment-shaped recess, more precisely relative to its center spot, that is the position of the center point of the circle defining the cross-section, in turn permits a particularly effective reduction of the surface's flow resistance. This is associated on one hand with a secure localization of the eddy inside the corresponding recess, and also on the other hand with an effective introduction of the fluid into the recess in cooperation with the lead-in section.

The second edge advantageously has a protrusion angled against the main flow direction and towards the recess for leading the fluid eddy over to a subsequent recess. Such a protrusion forces the fluid eddy to remain inside the recess so that the fluid particles of the fluid eddy stay in the recess and are not led out of the recess. Since additional fluid particles get into the recess due to the flow of the fluid over the body's surface, with a compressible fluid such as air, for example, the internal pressure of the fluid eddy rises and because of this the fluid eddy extends. Consequently, a portion of the fluid eddy will extend over the second edge and due to the angled protrusion, which is preferably inclined by an angle of 10° to 20°, especially preferably by 17° with respect to the main flow direction, is led to a subsequent recess in the main flow direction. Therefore an air cushion extending from recess to recess arises along the main flow direction which enables an efficient reduction in friction.

The circular-arc-segment of the cross-section of the recess advantageously measures between 270° and 310°, preferably between 280° and 300°, especially preferably 290°, such that the recess is open over an angular range of between 90° and 50°, preferably of between 80° and 60°, especially preferably of 70° of its cross-section. However, it may also be advantageous if the circular-arc-segment of the cross-section of the recess measures between 181° and 315°, especially between 260° and 290°, such that the recess is open over an angular range of between 179° and 45°, especially of between 100° and 75° of its cross-section. In this case, the angular range of the opening also depends on the anticipated velocity of the fluid flow. A correspondingly dimensioned opening of the recess serves in turn to particularly efficiently reduce the flow resistance of the surface and therefore of the body over which or around which the fluid flows.

A flow path according to the invention, in particular a supersonic flow path, comprises a body described above. An especially low-friction fluid flow through the flow path is guaranteed as a result. In particular, the flow path may be the inside of a jet engine in which a fluid flow with supersonic velocity may be at least partially present. A jet engine according to the invention and a lift device according to the invention are also provided with a body described above. In this case, the lift device, flow path or jet engine preferably have a surface over which fluid flows which surface is substantially completely provided with the structure described above.

According to a further aspect of the invention, a film comprises a structure for reducing a flow resistance of a body over or around which a fluid flows in a main flow direction, and on whose surface the film can be applied. In this case, the structure has at least one recess provided with a substantially circle-segment-shaped cross-section for inducing a fluid eddy. The film is characterized in that the structure has at least one lead-in section, which is angled with respect to the main flow direction towards the recess and which is arranged upstream of the recess in the main flow direction, for leading a fluid flow into the recess. By means of the structure, a fluid eddy can be induced within the recess and can be localized substantially within the recess. A film according to the invention is therefore suitable for creating a body according to the invention by coating a surface of virtually any body with the film.

A further aspect of the invention lies in the use of a surface structure over which a fluid can flow in a main flow direction, having at least one recess provided with a substantially circle-segment-shaped cross-section for inducing a fluid eddy, said recess having a lead-in section angled with respect to the main flow direction and arranged upstream of the recess in the main flow direction for leading a fluid flow into the recess for reducing a flow resistance of a body provided with the surface structure.

Further preferred embodiment emerge from the following description of the figures and the entirety of the claims.

### BRIEF DESCRIPTION OF THE FIGURES

FIG. 1 shows, in a lateral sectional view, a section of a body having a surface structure according to a preferred embodiment.

FIG. 2 shows, in a lateral sectional view, a portion of a body having a surface structure according to a further preferred embodiment.

### PREFERRED EMBODIMENT

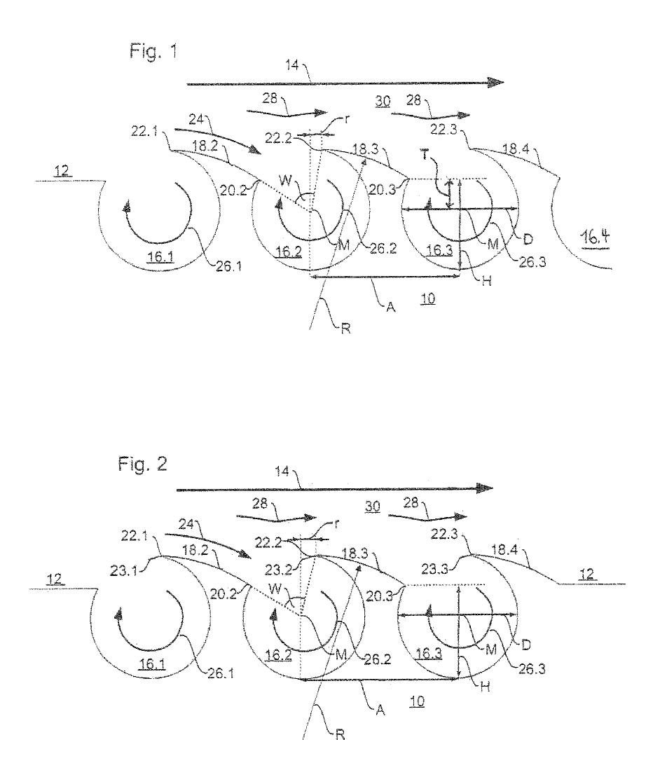

FIG. 1 shows a lateral sectional view of a body 10 along a surface 12 of body 10 over which a fluid 30 flows. Surface 12 has four recesses 16.1 . . . 16.4 lying side by side which have a circle-segment-shaped cross-section and preferably a surface of titanium dioxide or another largely inert and/or friction-reducing surface wherein recess 16.4 is only partially drawn. Four recesses 16.1 . . . 16.4 are in this case spaced apart by 1.25 times diameter D of the circle which defines the cross-section of the recesses. Provided between recesses 16.1 and 16.2 is a lead-in section 18.2 of recess 16.2, between recesses 16.2 and 16.3 is a lead-in section 18.3 of recess 16.3 and between recesses 16.3 and 16.4 is a lead-in section 18.4. The structure of the recesses with its features continues periodically towards the main flow direction. The description of the figures relates in each case to a portion of the whole structure. Particularly in recess 16.4 which is only partially shown, the properties described are applicable analogously even if this is not referred to explicitly.

The sectional plane of FIG. 1 runs in this case along a main flow direction 14 of fluid 30 above surface 12 of body 10. Recesses 16.1 . . . 16.4 are therefore evenly spaced apart along main flow direction 14 and extend substantially transverse to main flow direction 14, out of or into the drawing plane of FIG. 1. Distance A of recesses 16.1 . . . 16.4 from each other, i.e. the distance between the center points of adjacent recesses 16.1 . . . 16.4 is 1.25 times diameter D of each of recesses 16.1 . . . 16.4 in this preferred embodiment. Lead-in sections 18.2 . . . 18.4 present between adjacent recesses 16.1 . . . 16.4 are curved towards associated recesses 16.2 . . . 16.4 in the preferred embodiment shown in FIG. 1. The curvature is designed here in each case such that it has a radius of curvature R of 1.25 times, or 1.5 times in the case of the embodiment shown in FIG. 2, diameter D of recesses 16.2 . . . 16.4.

Recesses 16.2 . . . 16.3 each have an opening which is limited in each case in main flow direction 14 by a first edge 20.2 . . . 20.3 and a second edge 22.2 . . . 22.3. Edges 20.2, 20.3, 22.2, 22.3 thus also define an angular range W, which may be referred to as the opening angle and is shown in the example of recess 16.2, across which the relevant opening of a recess extends. Height H of first edges 20.2 . . . 20.3 over the lowest point of each recess 16.2 . . . 16.3 is 0.75 times diameter D of the corresponding recess in the preferred embodiment shown in FIG. 1. Second edges 22.2 . . . 22.3 are each offset with respect to first edges 20.2 . . . 20.3 in terms of height, that is to say pointing away from body 10. With respect to the position of center point M of each recess in main flow direction 14, the second edge is offset by a depth T of 0.25 times diameter D of the corresponding recess.

A fluid 30 flowing over surface 12, whose main flow direction 14 is defined by the global course of surface 12, arrives at lead-in sections 18.2 . . . 18.3 in its region directly adjacent to surface 12. Lead-in sections 18.2 . . . 18.3 lead a part flow 24 of fluid 30 into recesses 16.3 . . . 16.3 where a fluid eddy 26.1 . . . 26.3 is induced by the circular shape of the cross-section of recesses 16.2 . . . 16.3. Second edges 22.1 . . . 22.3 thereby separate fluid flow 24 led into the recess from a continuing fluid flow 28 which is led away via second edges 22.1 . . . 22.3 of recesses 16.1 . . . 16.3. Continuing fluid flow 28 and all layers above it are led by fluid eddies 26.1 . . . 26.3 in recesses 16.1 . . . 16.3 over surface 12 of body 10 with a very low flow resistance.

Fluid eddies 26.1 . . . 26.3 in recesses 16.1 . . . 16.3 are constantly driven by flowing fluid 30 and continue to exist for as long as fluid 30 flows over surface 12 of body 10. Due to the high rotational speed of eddies 26.1 . . . 26.3, only a minimal difference in velocity occurs between continuing fluid flow 28 and fluid eddy 26.1 . . . 26.3. Due to the minimal difference in velocity, hardly any flow resistance occurs in the region of the fluid eddies.

In addition, the fluid eddies create “air cushions” across which continuing fluid flow 28 is led and due to which fluid flow 28 does not come into direct contact or barely comes into direct contact with surface 12 of body 10 itself.

FIG. 2 shows a further embodiment in which second edge 22.1 . . . 22.3 having a tab 23.1 . . . 23.3 extending against the flow direction, angled towards the recess. The second preferred embodiment corresponds to that shown in FIG. 1.

1. Body having at least one surface over which a fluid can flow, said surface having a global course that defines a main flow direction over the surface,
wherein the surface at least partially has a structure for reducing a flow resistance of the body, the structure having
at least one recess for inducing a fluid eddy and
at least one lead-in section angled with respect to the main flow direction towards the recess
which is arranged upstream of the recess in the main flow direction for leading a fluid flow into the recess,
characterized in that
the recess is provided with a circle-segment-shaped cross-section and formed such that by a fluid flow led over the surface a fluid eddy is induced within the recess which recess is configured such that the fluid eddy substantially remains within the recess and creates air cushions across which continuing fluid flow is led.

2. Body according to claim 1, wherein the recess extended transverse to the main flow direction is in particular groove-shaped.

3. Body according to claim 1, wherein the structure has a plurality of recesses wherein the majority of the recesses are arranged one behind the other, particularly in the main flow direction.

4. Body according to claim 3, wherein adjacent recesses, are spaced apart from each other by 1 to 6 times the diameter of the circle-segment-shaped cross-section, depending on the density, viscosity and temperature of the fluid.

5. Body according to claim 1, wherein the lead-in section is configured in a straight line and/or curved, wherein the radius of curvature in particular measures 2 to 6 times the diameter (D) of the circle-segment-shaped cross-section, depending on density, viscosity and temperature of the fluid.

6. Body according to claim 1, wherein the lead-in section is configured in such a manner that the inclination between the main flow direction and the tangent parallel to the main flow direction is greater at a first point of the lead-in section than at a second point which is situated upstream in the main flow direction with respect to the first point.

7. Body according to claim 1, wherein the recess has a first edge situated upstream in the main flow direction between the lead-in section and the recess and a second edge situated downstream between the recess and a portion of the surface situated downstream, wherein the first edge is offset with respect to the second edge towards the inside of the body in order to induce the fluid eddy in the recess.

8. Body according to claim 7, wherein the point of the recess situated furthest upstream is offset with respect to the first edge towards the inside of the body in order to localize the fluid eddy inside the recess.

9. Body according to claim 7, wherein the second edge is offset with respect to the center spot (M) of the recess in the main flow direction by 0.1 to 0.6 times the radius of the circle-segment-shaped cross-section,

10. Body according to claim 7, wherein the second edge has a protrusion against the main flow direction and angled towards the recess for leading the fluid eddy over to a subsequent recess.

11. Body according to claim 1, wherein the circular-arc-segment of the cross-section of the recess measures between 181° and 315°, depending on the density, viscosity and temperature of the fluid,
such that the recess is open over an angular range of between 179° and 45°, of its cross-section.

12. Flow path having a body according to claim 1.

13. Jet engine having a body according to claim 1.

14. Lift device having a body according to claim 1.

15. Film having a structure for reducing a flow resistance of a body over or around which a fluid flows in a main flow direction, and on whose surface the film can be applied, wherein the structure has
at least one recess for inducing a fluid eddy and at least one lead-in section angled with respect to the main flow direction towards the recess which is arranged upstream of the recess in the main flow direction for leading a fluid flow into the recess, wherein
the recess is provided with a circle-segment-shaped cross-section and formed such that by a fluid flow led over the surface a fluid eddy is induced within the recess which recess is configured such that the fluid eddy substantially remains within the recess and creates air cushions across which continuing fluid flow is led.

16. (canceled)

17. Body according to claim 7, wherein the second edge is offset with respect to the center spot (M) of the recess in the main flow direction by 0.3 times the radius of the circle-segment-shaped cross-section.

18. Body according to claim 11, wherein the circular-arc-segment of the cross-section of the recess measures between 260° and 290° such that the recess is open over an angular range of between 100° and 75° of its cross-section.

19. Flow path according to claim 12 wherein said flow path is a supersonic flow path.
